(19) United States
(12) Patent Application Publication
(10) Pub. No.: US 2010/0293939 A1
(43) Pub. Date: Nov. 25, 2010

(54) THERMO ELEMENT

(76) Inventor: Yukio ONISHI, Tokorozawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/780,815

(22) Filed: May 14, 2010

(30) Foreign Application Priority Data
May 19, 2009 (JP) 2009-120876
Oct. 22, 2009 (JP) 2009-243203

(51) Int. Cl. F02G 1/043; F16J 15/16

(52) U.S. Cl. 60/527; 277/345

(57) ABSTRACT

An object of the present invention is to prevent a sealing member from being degraded and to provide a thermo-element having a good responsiveness and an improved durability.

Grooves (41) are formed on the inner surface of a piston insertion bore of a sleeve (40) of a thermo-element. Alternatively, ribs (42) are formed on the outer surface of the sleeve. When the sleeve is pushed and deformed by a wax, the sleeve is bent at the grooves or at the ribs. The piston insertion bore has an inner diameter equal to or larger than the outer diameter (6d) of the piston (6), or the piston insertion bore has an inner diameter (40d) smaller than the outer diameter of the piston. In the latter case, the deformation of the sleeve when pushed and deformed is decreased.

### FIELD OF THE INVENTION

The present invention relates to a thermo-element, or a thermo-actuator in which expansion and contraction of wax by a temperature change is utilized.

### DESCRIPTION OF THE PRIOR ART

A thermo-element using a thermally expandable component, such as wax or the like, as a temperature sensor has been used conventionally. The thermo-element converts a change in volume of the wax due to a temperature change into an axial linear movement of the piston. There are various types of thermo-elements, including a diaphragm-type as shown in FIG. 1 and a sleeve-type as shown in FIG. 2.

A thermo-element of diaphragm-type as shown in FIG. 1 includes a cylindrical casing 1 having a bottom, and a cylindrical guide member 5 connected to the casing 1. An inside space of the casing 1 is filled with a volume of wax 2, and a diaphragm 3 (an elastic sealing member) seals the upper surface of the wax 2. A gummy fluid 4 is filled between a contact surface 5a in the base end portion of the guide member 5 and an upper side of the diaphragm 3, the gummy fluid 4 being a deformable non-compressible fluid. Within the guide tube 5b of the guide member 5, a rubber piston 7, a protective sheet 8 and a piston 6 are arranged above the gummy fluid 4.

As an ambient temperature rises, the wax 2 expands and thus the diaphragm 3 bulges upward and pushes up the gummy fluid 4 located above the diaphragm 3. The gummy fluid 4 is deformed and enters into the guide tube 5b and pushes the piston 6 upward via the rubber piston 7 and the protective sheet 8. As the temperature decreases, the wax 2 contracts, and then a load (not shown) applied to the piston 6 can press the piston 6 downward. In this way, the piston 6 can move in and out of the guide member 5 when the temperature changes.

As used in this specification, the term “up” refers to the upward direction and the term “down” the downward direction in the attached drawings.

A thermo-element of sleeve-type as shown in FIG. 2 includes a cylindrical casing 1 having a bottom, a wax 2 filled in the casing, and a sleeve 9 (an elastic sealing member) which seals an upper end portion of the wax 2. A piston insertion bore is formed at the center of the sleeve 9. An upper side of the sleeve 9 is connected to the casing 1 via a retaining plate 10. A cylindrical guide member 5 is provided at the upper end portion of the casing 1. The base end portion of the guide member 5 is connected to the upper end portion of the casing 1. A piston 6 extends from the inside of the piston insertion bore of the sleeve 9 and through the guide member 5.

As an ambient temperature rises, the wax 2 expands and thus pushes and deforms the sleeve 9, which in turn pushes out the piston 6 inserted in the sleeve 9 upwardly. As the temperature decreases, the wax 2 contracts, then a load (not shown) being applied to the piston 6 can press down the piston 6 back to its previous position. In this way, the piston 6 can be moved in and out of the guide member 5 when the temperature changes.

The problem of the thermo-element of sleeve type is that the piston repeats reciprocating motion by expanding and contracting of the wax, and thus the sleeve degrades. Another problem is that the sleeve is fastened to the piston when the thermo-element is not used for a long time.

In the thermo-element of sleeve type shown in FIG. 2, when the temperature rises and the wax expands, the wax pushes up the piston 6 in the piston insertion bore upward, and the piston insertion bore of the sleeve is pushed and deformed. When the temperature is lowered and the wax contracts, the piston insertion bore of the sleeve is expanded and the piston 6 in the piston insertion bore goes back downward to the original position. Thus when the temperature rising and lowering is repeated, the portion of the sleeve near the piston insertion bore is deformed repeatedly. Thus the sleeve degrades and tears, and thus has poor durability.

As shown in the patent document 1, the inventor of the present invention aims to provide a thermo-element which has a simple construction and good responsiveness, and invented a thermo-element comprising a thick sealing member instead of a diaphragm and a gummy fluid of prior art. The thick sealing member functions both as a diaphragm that can be deformed and seals the gummy fluid and also as a gummy fluid operable to push the piston. The thick sealing member is deformable and non-compressive. Thus a rubber piston and a protective sheet, which were necessary in the conventional thermo-element, can be eliminated. Thus a thermo-element having a simple structure can be obtained.

FIG. 3 shows a longitudinal sectional view of a thermo-element comprising a thick sealing member 20 of the patent document 1 (JP Patent No. 3971452). The thermo-element comprises a cylindrical casing 1 having a base; a cylindrical guide member 5 which engages one end of casing 1; a piston 6 held inside the guide member so that the piston can slide freely; and a thick sealing member 20 arranged between the guide member and the wax for enclosing the wax 2 in the casing 1 and for moving-in and moving-out the piston 6.

The thick sealing member 20 is formed of a rubber elastomer, and the thick sealing member has a piston insertion bore formed in a central portion thereof for inserting one end of the piston 6. The thick sealing member has an annular rib arranged at an outer peripheral region and a thick portion having a thickness which gradually increases from the rib to the piston insertion bore. When the wax 2 expands by a temperature change, the thick sealing member 20 is deformed and pushes up the piston 6.

In the thick sealing member 20 shown in FIG. 3, the upper surface and the inner surface of the piston insertion bore 20a of the thick sealing member are formed of a high-hardness rubber and the rest 20b of the thick sealing member is formed of a low-hardness rubber.

Patent document 2 discloses a composite material composition obtained by kneading a thermoplastic resin and a carbon fiber.

A thermo-element having an improved durability is desired.

[Patent document 1] JP Patent No. 3971452
[Patent document 2] JP 2005-325345

### SUMMARY OF THE INVENTION

### Problem to be Solved by the Invention

An object of the present invention is to provide a thermo-element having an improved durability.

### MEANS TO SOLVE THE PROBLEM

In the sleeve type thermo-element of prior art, when the wax expands by a temperature rise and the piston is pushed out in upward direction, the piston insertion bore is pushed and deformed. The inventor of the present invention found that in the case where the sleeve has longitudinal grooves on the inner surface of the piston insertion bore, when the sleeve is pushed and deformed, the sleeve is bent at the grooves, and thus the rest of the sleeve is not over-bent and is not bent irregularly.

Instead of the longitudinal grooves on the inner surface of the piston insertion bore, the sleeve may have longitudinal ribs on the outer surface of the sleeve. In this case, when the sleeve is pushed and deformed, the sleeve is bent at the ribs. The ribs also reinforces the sleeve.

In the case where the piston insertion bore has an inner diameter which is equal to or a little larger than the outer diameter of the piston, resistance to sliding the piston in the sleeve is decreased, and thus the piston is smoothly pushed out and returns.

In the case where the piston insertion bore has an inner diameter which is smaller than the outer diameter of the piston, when the piston is inserted into the piston insertion bore, the piston expands the piston insertion bore along the grooves, and when the piston is moved upward, the inner diameter of the piston insertion bore returns to its original inner diameter when formed and then the sleeve is pushed and deformed, and thus the deformation of the piston is reduced.

One aspect of the present invention is a thermo-element comprising a cylindrical casing having a bottom; a cylindrical guide member engaging at one end of the casing; a wax filled in the casing, said wax expanding and contracting due to a temperature change; an elastic sealing member which seals the wax in the casing, said elastic sealing member having a piston insertion bore at the center thereof; and a piston which moves in the axial direction by expanding and contracting of the wax, wherein,

said elastic sealing member has longitudinal grooves on the inner surface of the piston insertion bore in the longitudinal direction of the piston insertion bore, and when the wax expands and the piston is moved upward, the elastic sealing member is bent at the grooves and the piston insertion bore is pushed and deformed (flattened).

When the temperature rises and the wax expands, the longitudinal grooves on the piston insertion bore are deformed, the piston is pushed upward, the elastic sealing member is bent at the groove, and the elastic sealing member (sleeve) is deformed (flattened). Because the elastic sealing member is deformed along the grooves, localized bent does not occur. Deformation of the elastic sealing member is smaller than in the prior art sleeve.

When the temperature falls and the wax is contracted, the piston goes down into the piston insertion bore, and the inner diameter of the elastic sealing member goes back to the original length. Because the piston insertion bore has the longitudinal grooves, the piston does not adhere to the elastic sealing member at the grooves, and thus the piston is prevented from adhering to the elastic sealing member.

In this case, the deformation of the sleeve of the present invention is smaller than the sleeve of the prior art.

The piston insertion bore may have an inner diameter which is equal to or larger than the outer diameter of the piston when not deformed. The inner diameter of the piston insertion bore may be 0% to +10% larger than the outer diameter of the piston. In this case, the resistance of sliding the piston in the piston insertion bore decreases.

If the inner diameter of the piston insertion bore is larger than this range, there is an undesirable gap between the sleeve and the piston,

Preferably, the piston insertion bore has an inner diameter which is smaller than the outer diameter of the piston when not deformed. The inner diameter of the piston insertion bore may be −7% to 0% smaller than the outer diameter of the piston.

If the inner diameter of the piston insertion bore is smaller than this range, the expansion of the sleeve when inserting the piston is undesirably large.

In the case where the inner diameter of the piston insertion bore is smaller than the outer diameter of the piston, when the piston is inserted into the piston insertion bore, the piston expands the piston insertion bore along the groove. When the temperature rises, the piston is pushed upward, and the sleeve is bent and deformed at the groove. The inner diameter of the piston insertion bore will go back to the original dimension which is smaller than the outer diameter of the piston, and then the sleeve is further deformed, and thus the deformation of the sleeve is reduced.

Preferably, the piston insertion bore has an inner diameter smaller than the outer diameter of the piston near the entrance of the piston insertion bore, and has an inner diameter equal to or larger than the outer diameter of the piston at the lower portion of the piston insertion bore, and the longitudinal grooves are provided on the lower portion which has an inner diameter equal to or larger than the outer diameter of the piston, and the longitudinal grooves are not provided near the entrance of the piston insertion bore.

The inner diameter of the piston insertion bore may be 0% to +10% larger than the outer diameter of the piston near the entrance of the piston insertion bore, and may be −7% to 0% smaller than the outer diameter of the piston at the lower portion of the piston insertion bore.

In this case, because the groove is not formed near the entrance of the piston insertion bore, the piston fits into the sleeve, and the groove at the lower portion can be sealed. Thus a foreign matter such as liquid or solid is prevented from entering into the piston insertion bore.

Preferably, the piston insertion bore has one groove at each opposite side, or the piston insertion bore has four grooves at regular intervals.

Preferably, the piston insertion bore has a roughened surface so that the elastic sealing member is not adhered to the piston.

The die for the piston insertion bore used in forming the elastic sealing member may be sandblasted, and thus the inner surface of the piston insertion bore will be roughened.

Another aspect of the present invention is a thermo-element comprising a cylindrical casing having a bottom; a cylindrical guide member engaging at one end of the casing; a wax filled in the casing, said wax expanding and contracting due to a temperature change; an elastic sealing member which seals the wax in the casing, said elastic sealing member having a piston insertion bore at the center thereof; and a piston which moves in the axial direction by expanding and contracting of the wax, wherein:

said elastic sealing member has longitudinal ribs on the outer surface of the elastic sealing member in the longitudinal direction of the piston insertion bore, and when the wax expands and the piston is moved upward, the elastic sealing member is bent at the ribs and the piston insertion bore is pushed and deformed.

The rib reinforces the elastic sealing member when it is deformed.

The piston insertion bore may have an inner diameter which is equal to or larger than the outer diameter of the piston. The inner diameter of the piston insertion bore may be 0% to +10% larger than the outer diameter of the piston.

Preferably, the piston insertion bore has an inner diameter smaller than the outer diameter of the piston. The inner diameter of the piston insertion bore may be −7% to 0% smaller than the outer diameter of the piston.

Preferably, the piston insertion bore has an inner diameter smaller than the outer diameter of the piston near the entrance of the piston insertion bore, and has an inner diameter equal to or larger than the outer diameter of the piston at the lower portion of the piston insertion bore.

Preferably, the piston insertion bore has one groove at each opposite side, or the piston insertion bore has four grooves at regular intervals.

Preferably, the piston insertion bore has a roughened surface so that the thick sealing member is not fixed to the piston.

Preferably, the thermo-element is a sleeve type thermo-element, and the elastic sealing member is a sleeve which seals the wax in the casing and has the piston insertion bore at the center thereof for inserting one end of the piston.

Or, the thermo-element may be a thick sealing member made of a non-compressive gummy elastic body, arranged between the guide member and the wax for sealing the wax, and having the piston insertion bore at the center thereof for inserting one end of the piston.

The thick sealing member is a composite member of a diaphragm and a gummy fluid of the sleeve type thermo-element.

In the thermo-element using the thick sealing member (as an elastic sealing member) shown in FIG. 3, the piston insertion bore may have grooves on the inner surface of the piston insertion bore of the thick sealing member.

A further aspect of the present invention is a thermo-element including a wax which expands and contracts due to a temperature change, and pushes up and down the piston, comprising:

a cylindrical casing having a opening at one end for filling the wax;

a cylindrical guide member engaging at one end of the casing;

a piston slidably positioned in the bore of the guide member; and

a thick sealing member arranged between the guide member and the wax for sealing the wax in the casing, the thick sealing member having a piston insertion bore for inserting one end of the piston, an annular rib at an outer peripheral region thereof, and a thick portion between the rib and the piston insertion bore, the thickness of the thick portion increasing from the rib to the piston insertion bore; wherein

said thick sealing member has longitudinal grooves on the inner surface of the piston insertion bore in the longitudinal direction of the piston insertion bore, and when the wax expands and the piston is moved upward, the elastic sealing member is bent at the grooves and the piston insertion bore is pushed and deformed.

The piston insertion bore may have an inner diameter which is equal to or larger than the outer diameter of the piston. The inner diameter of the piston insertion bore may be 0% to +10% larger than the outer diameter of the piston.

Preferably, the piston insertion bore has an inner diameter which is smaller than the outer diameter of the piston. The inner diameter of the piston insertion bore may be −7% to 0% smaller than the outer diameter of the piston.

Or, instead of the grooves on the piston insertion bore, the thick sealing member may have ribs at the outer surface thereof.

A further aspect of the present invention is a thermo-element including a wax which expands and contracts due to a temperature change, and pushes up and down the piston, comprising:

a cylindrical casing having a opening at one end for filling the wax;

a cylindrical guide member engaging at one end of the casing;

a piston slidably positioned in the bore of the guide member; and

a thick sealing member arranged between the guide member and the wax for sealing the wax in the casing, the thick sealing member having a piston insertion bore for inserting one end of the piston, an annular rib at an outer peripheral region thereof, and a thick portion between the rib and the piston insertion bore, the thickness of the thick portion increasing from the rib to the piston insertion bore; wherein

said thick sealing member has longitudinal ribs on the outer surface thereof, and when the wax expands and the piston is moved upward, the thick sealing member is bended at the ribs and the piston insertion bore is pushed and deformed.

A yet further aspect of the present invention is an elastic sealing member used in a thermo-element in which a piston is moved by expanding and contracting of a wax, wherein

the elastic sealing member has a piston insertion bore at the center thereof; said elastic sealing member has longitudinal grooves on the inner surface of the piston insertion bore in the longitudinal direction of the piston insertion bore, and when the wax expands and the piston is moved upward, the elastic sealing member is bent at the grooves and the piston insertion bore is pushed and deformed.

A yet further aspect of the present invention is an elastic sealing member used in a thermo-element in which a piston is moved by expanding and contracting of a wax, wherein

the elastic sealing member has a piston insertion bore at the center thereof; said elastic sealing member has longitudinal ribs on the outer surface of the elastic sealing member in the longitudinal direction of the piston insertion bore, and when the wax expands and the piston is moved upward, the elastic sealing member is bent at the ribs and the piston insertion bore is pushed and deformed.

In the present invention, a wax mixture in which carbon fiber is mixed can be used as a thermal expansion body.

A thermo-element which has good responsiveness, a simple structure and high durability can be obtained.

### EFFECT OF THE INVENTION

The thermo-element of the present invention has longitudinal grooves in the piston insertion bore of the elastic sealing member, or has ribs on the outer surface thereof. When the wax expands and the piston is pushed out, the elastic sealing member deforms at the grooves or the ribs, and thus localized bending will not occur. When the elastic sealing member has ribs, the elastic sealing member is reinforced by the ribs. Thus the elastic sealing member has good durability, and a thermo-element having good durability can be provided.

### BRIEF DESCRIPTION OF THE DRAWINGS

FIG. 1 is a longitudinal sectional view of a thermo-element of a diaphragm type.

FIG. 2 is a longitudinal sectional view of a thermo-element of a sleeve type.

FIG. 3 is a longitudinal sectional view of a thermo-element of the patent document 1.

FIG. 4A is a top view of the sleeve of the first embodiment of the sleeve type thermo-element.

FIG. 4B is a longitudinal sectional view thereof.

FIG. 4C is a sectional view thereof along A-A line in FIG. 4B.

FIG. 5A is a top view of the sleeve of the second embodiment.

FIG. 5B is a longitudinal sectional view thereof.

FIG. 5C is a sectional view thereof along B-B line in FIG. 5B.

FIG. 6A is a top view of the sleeve of the third embodiment.

FIG. 6B is a longitudinal sectional view thereof.

FIG. 6C is a sectional view thereof along C-C line in FIG. 6B.

FIG. 7B is a longitudinal sectional view of a thermo-element having the sleeve of the first embodiment shown in FIG. 4 wherein the piston is at a raised position.

FIG. 7C is a sectional view of the thermo-element along D-D line in FIG. 7B.

FIG. 8B is a longitudinal sectional view of a thermo-element having the sleeve of the second embodiment shown in FIG. 5 wherein the piston is at raised position.

FIG. 8C is a sectional view of the thermo-element along E-E line in FIG. 8B.

FIG. 9B is a longitudinal sectional view of a thermo-element having the sleeve of the third embodiment shown in FIG. 6 wherein the piston is at raised position.

FIG. 9C is a sectional view of the thermo-element along F-F line in FIG. 9B.

FIG. 10A is a top view of the sleeve of the fourth embodiment.

FIG. 10B is a longitudinal sectional view thereof.

FIG. 10C is a sectional view thereof along G-G line in FIG. 10B.

FIG. 11A is a top view of the thick sealing member of the fifth embodiment.

FIG. 11B is a longitudinal sectional view of the thick sealing member.

FIG. 11C is a sectional view of the thick sealing member along H-H line in FIG. 11B.

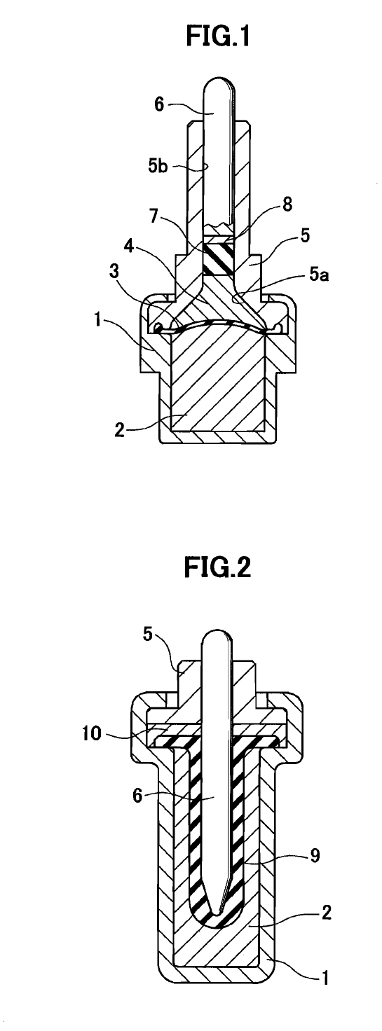

### DESCRIPTION OF THE PREFERRED EMBODIMENTS

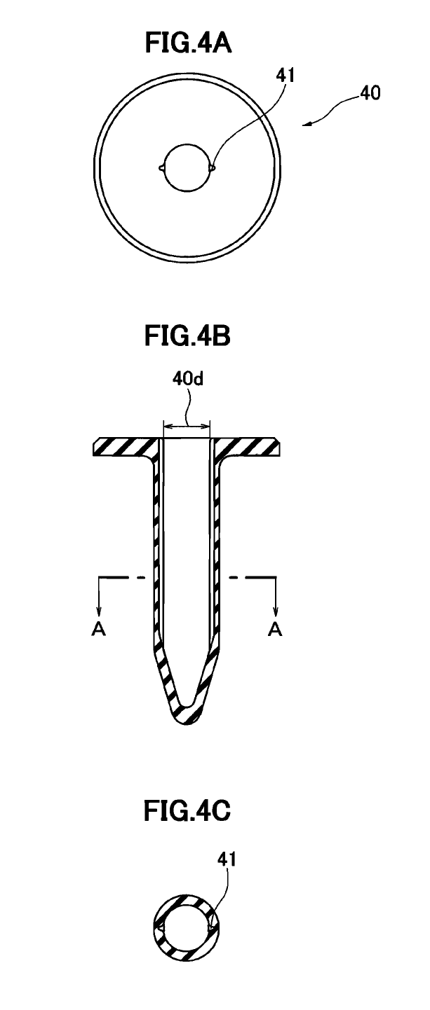

Preferred embodiments of the present invention will be described with reference to FIGS. 4A-11C. The first and second embodiments of the present invention are each a sleeve type thermo-element. The inner surface of the piston insertion bore of the sleeve has longitudinal grooves, and when the piston is pushed out, the sleeve is bent at the groove.

In the third embodiment of the present invention, the sleeve has longitudinal ribs on the outer surface of the sleeve, and when the piston is pushed out, the sleeve is bent at the ribs.

The inner diameter of the piston insertion bore is substantially equal to the outer diameter of the piston. The inner diameter of the piston insertion bore may be larger than the outer diameter of the piston. Or, the inner diameter of the piston insertion bore may be smaller than the outer diameter of the piston. In the latter case, when the piston is inserted into the bore, the sleeve is expanded. When the temperature rises and the piston is pushed out, the deformation of the sleeve is smaller than that of the sleeve having a diameter equal to the outer diameter of the piston.

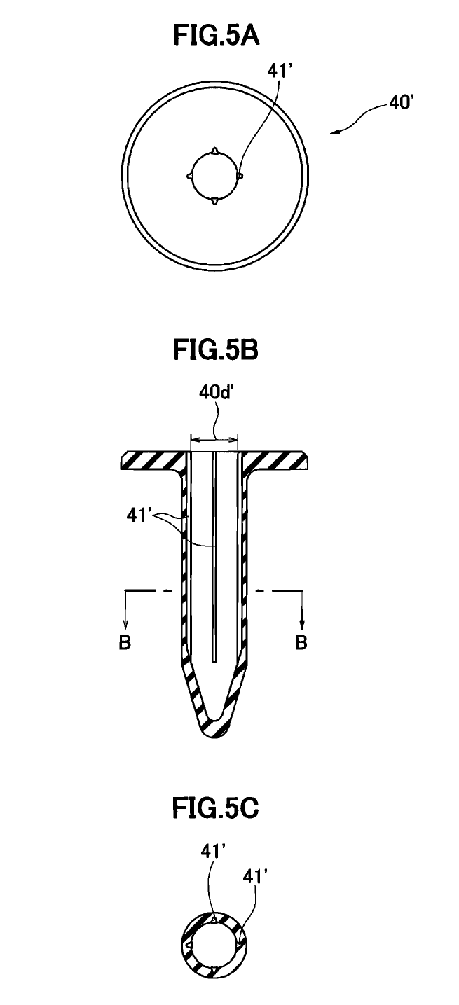

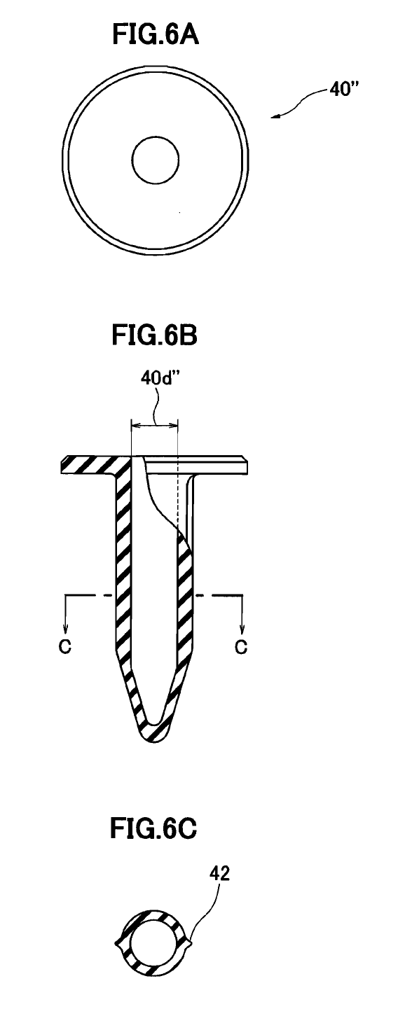

FIG. 4A-4C shows a sleeve 40 of the first embodiment of the sleeve type thermo-element. FIG. 5A-5C shows a sleeve 40′ of the second embodiment. FIG. 6A-6C shows a sleeve 40″ of the third embodiment.

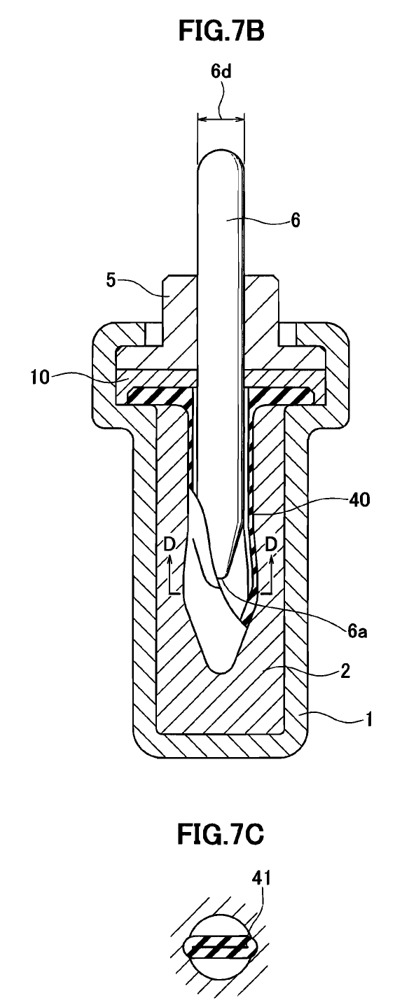

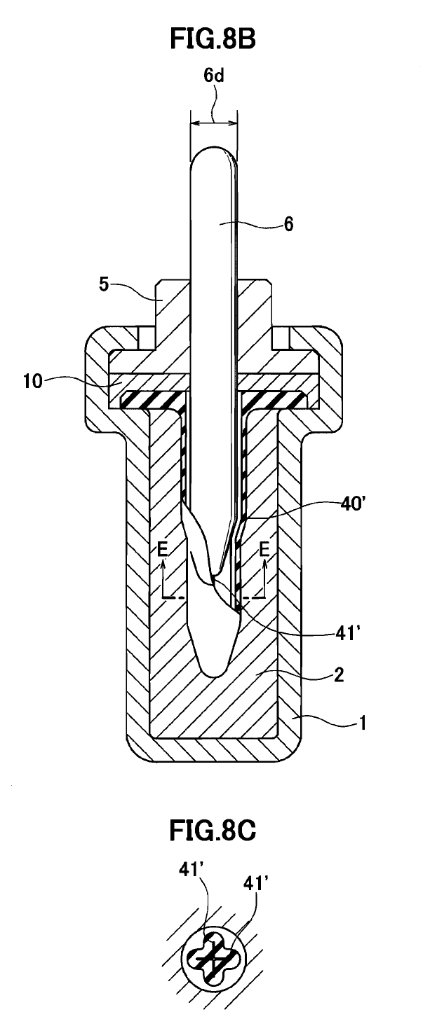

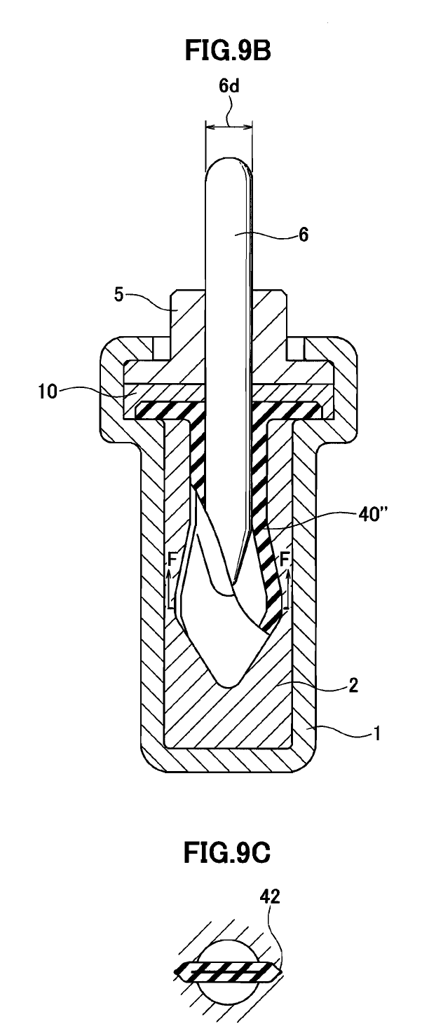

FIG. 7B-7C shows a thermo-element using the sleeve 40 of the first embodiment shown in FIG. 4A-4C, wherein the piston is at a raised position. FIG. 8B-8C shows a thermo-element using the sleeve 40′ of the second embodiment shown in FIG. 5A-5C, wherein the piston is at a raised position. FIG. 9B-9C shows a thermo-element using the sleeve 40″ of the third embodiment shown in FIG. 6A-6C, wherein the piston is at a raised position.

FIG. 4A-4C is a sleeve 40 of the first embodiment of the sleeve type thermo-element. FIG. 4A is a top view, FIG. 4B is a longitudinal sectional view thereof, and FIG. 4C is a sectional view thereof along A-A line in FIG. 4B. The inner diameter 40d of the piston insertion bore of the sleeve 40 not deformed is substantially equal to the outer diameter 6d of the piston 6. Two longitudinal grooves 41 are formed on the inner surface of the sleeve 40. When the wax expands and the piston 6 is pushed out, the sleeve 40 is bent at the two grooves 41.

In the first embodiment, the inner diameter 40d of the sleeve 40 is substantially equal to the outer diameter 6d of the piston 6. Instead, the inner diameter 40d of the sleeve 40 may be smaller than the outer diameter 6d of the piston 6.

FIG. 5A-5C is a sleeve 40′ of the second embodiment of the sleeve type thermo-element. FIG. 5A is a top view, FIG. 5B is a longitudinal sectional view thereof, and FIG. 5C is a sectional view thereof along B-B line in FIG. 5B. The inner diameter 40d′ of the piston insertion bore of the sleeve 40′ when formed is substantially equal to the outer diameter 6d of the piston 6. Four longitudinal grooves 41′ are formed on the inner surface of the sleeve 40′. The sleeve of the second embodiment is the same as that of the first embodiment in other points.

The opposing surfaces of the grooves 41′ have some clearance. When the wax expands, the opposing surfaces of the groove contact each other. When the wax is further expanded and pushes out the piston, the portion of the elastic sealing member where the piston is pushed out is bent at four grooves 41′ and deformed.

In the second embodiment, the inner diameter 40d′ of the sleeve 40′ is substantially equal to the outer diameter 6d of the piston 6. The inner diameter 40d′ of the sleeve 40′ may be larger than the outer diameter 6d of the piston 6, or may be smaller than the outer diameter 6d of the piston 6.

FIG. 6A-6C is a sleeve 40″ of the third embodiment of the sleeve type thermo-element. FIG. 6A is a top view, FIG. 6B is a longitudinal sectional view thereof, and FIG. 6C is a sectional view thereof along C-C line in FIG. 6B. Two longitudinal ribs 42 are formed on the outer surface of the sleeve 40″. When the wax expands and pushes out the piston 6, the sleeve 40″ is bent at the two ribs 42 and is deformed. The ribs 42 reinforce the bent portion.

In the third embodiment, two ribs 42 are provided. Instead, four ribs 42 may be provided.

In the third embodiment, the inner diameter 40d″ of the sleeve 40″ is substantially equal to the outer diameter 6d of the piston 6. The inner diameter 40d″ of the sleeve 40″ may be larger than the outer diameter 6d of the piston 6, or it may be smaller than the outer diameter 6d of the piston 6.

Further, in the third embodiment, two ribs 42 are provided on the outer surface of the sleeve 40″. In addition to the ribs 42, two grooves 41 or four grooves 41′ may be provided on the inner surface of the piston insertion bore.

Now, how the sleeve deforms when the temperature rises and the piston 6 is pushed out will be explained.

FIG. 7B is a longitudinal sectional view of a thermo-element having the sleeve 40 of the first embodiment shown in FIG. 4 wherein the piston is at a raised position. FIG. 7C is a sectional view thereof along D-D line in FIG. 7B. When wax 2 expands and the piston 6 is raised, the portion of the sleeve 40 lower than the lower end 6a of the piston 6 is pushed and deformed. At this time, the sleeve 40 is bent at two grooves 41, the piston insertion bore of the sleeve 40 is deformed in the transverse direction of FIG. 7C, and the sleeve 40 is deformed to a flat form.

FIG. 8B is a longitudinal sectional view of a thermo-element having the sleeve 40′ of the second embodiment shown in FIG. 5 wherein the piston is at a raised position. FIG. 8C is a sectional view thereof along E-E line in FIG. 8B. When wax 2 expands and the piston 6 is raised, the portion of the sleeve 40′ lower than the lower end 6a of the piston 6 is pushed and deformed. At this time, the sleeve 40′ is bent at four grooves 41′, the piston insertion bore of the sleeve 40′ is deformed as shown in FIG. 8C, and the sleeve 40′ is deformed in the transverse direction and longitudinal direction of FIG. 8C.

FIG. 9B is a longitudinal sectional view of a thermo-element having the sleeve 40 of the third embodiment shown in FIG. 6 wherein the piston is at a raised position. FIG. 9C is a sectional view thereof along F-F line in FIG. 9B. When wax 2 expands and the piston 6 is raised, the portion of the sleeve 40″ lower than the lower end 6a of the piston 6 is pushed and deformed. At this time, the sleeve 40″ is bent at the ribs 42 formed on the outer surface of the sleeve 40″, the piston insertion bore of the sleeve 40″ is deformed in the transverse direction of FIG. 9C, and the sleeve 40″ is deformed to a flat form.

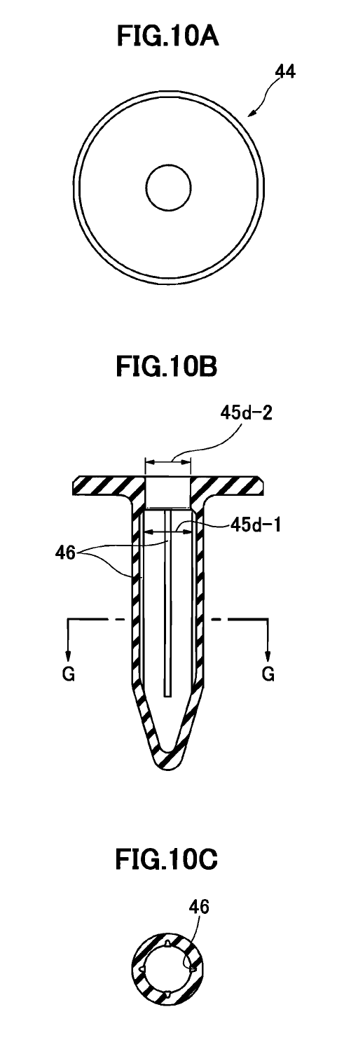

FIG. 10A is a top view of the sleeve 44 of the fourth embodiment. FIG. 10B is a longitudinal sectional view thereof, and FIG. 10C is a sectional view thereof along G-G line of FIG. 10B. The inner diameter 45d-2 of the upper portion of the piston insertion bore is smaller than the outer diameter 6d of the piston 6. The inner diameter 45d-1 of the lower portion of the piston insertion bore is substantially equal to the outer diameter 6d of the piston 6. Four grooves 46 are formed on the inner surface of the lower portion of the piston insertion bore having the inner diameter 45d-1.

Because the inner diameter of the piston insertion bore near the opening is smaller than the outer diameter of the piston and there are no grooves near the opening of the piston insertion bore, the piston 6 contacts the sleeve 44, and the grooves at the lower portion can be sealed. Thus a foreign body such as liquid or solid is prevented from entering into the piston insertion bore.

According to the first to fourth embodiments of the present invention, a thermo-element having good durability can be obtained.

### (Thick Sealing Member)

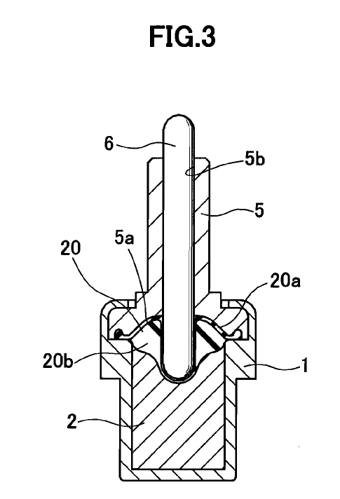

The first to fourth embodiments of the present invention are sleeve type thermo-elements. The present invention can be applied to a thermo-element using the thick sealing member shown in FIG. 3 (patent document 1). That is, grooves may be provided on the inner surface of the piston insertion bore of the thick sealing member.

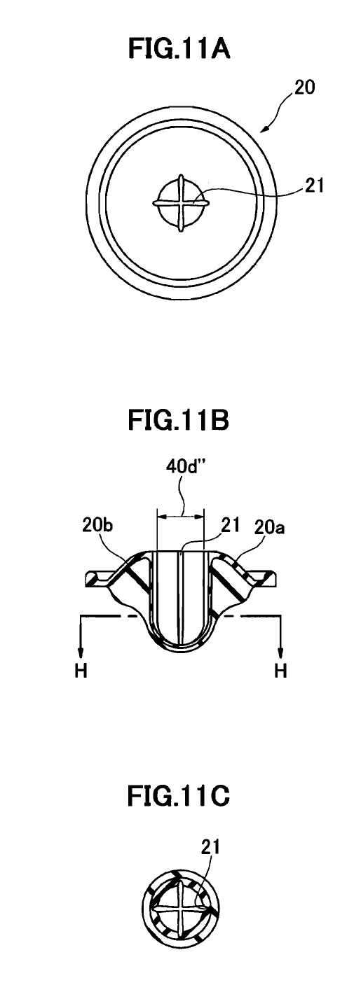

FIG. 11A-11C show the thick sealing member of the fifth embodiment. The thick sealing member 20 is made of a gummy elastic body. The thick sealing member has a piston insertion bore at the center thereof for inserting one end of the piston, an annular rib at an outer peripheral region thereof, and a thick portion between the rib and the piston insertion bore, the thickness of the thick portion increasing gradually from the rib to the piston insertion bore. When the wax expands due to a temperature change and the piston is moved upward, the thick sealing member 20 is deformed and pushes up the piston.

The upper surface and the inner surface 20a of the thick sealing member is made of rubber having high hardness and the rest 20b is made of rubber having low hardness. Grooves 21 are provided on the inner surface of the piston insertion bore.

FIG. 11A is a top view of the thick sealing member of the fifth embodiment, FIG. 11B is a longitudinal sectional view thereof, and FIG. 11C is a sectional view thereof along H-H line in FIG. 11 B. The inner diameter 40d″ of the piston insertion bore of the thick sealing member 20 is substantially equal to the outer diameter 6d of the piston 6. Four grooves 21 are formed in the longitudinal direction on the inner surface of the piston insertion bore of the thick sealing member 20. When the wax expands and the piston 6 is pushed up, the thick sealing member 20 is bent at four grooves 21 and is deformed.

In the fifth embodiment, either four grooves 21 or two grooves 21 may be formed.

In the fifth embodiment, the inner diameter 40d″ of the thick sealing member 20 is substantially equal to the outer diameter 6d of the piston 6. The inner diameter 40d′ of the thick sealing member 20 may be larger or smaller than the outer diameter 6d of the piston 6.

Further, as described in the fourth embodiment shown in FIG. 10, the inner diameter 40d″ of the upper portion of the piston insertion bore of the thick sealing member 20 may be smaller than the outer diameter 6d of the piston 6, and that of the lower portion thereof may be substantially equal to the outer diameter 6d of the piston 6, and the grooves may be formed only on the lower portion.

Further, instead of the grooves 21 or in addition to the grooves 21, ribs may be formed on the outer surface of the thick sealing member.

### INDUSTRIAL APPLICABILITY

The thermo-element of the present invention can be used as a temperature sensor or a thermo actuator.

### EXPLANATION OF REFERENCE NUMERALS

1 casing
2 wax (wax mixture)
3 diaphragm
4 gummy fluid
5 guide member
5a contact surface
5b guide tube
6 piston
6d outer diameter of piston
7 rubber piston
8 protective sheet
9 sleeve
10 retaining plate
20 thick sealing member
20a high-hardness portion
20b low-hardness portion
21 groove
40, 40′, 40″ sleeve
40d, 40d′, 40d″ inner diameter of piston insertion bore
40-1, 40-2 inner diameter of piston insertion bore
41, 41′ groove

What is claimed is:

1. A thermo-element comprising a cylindrical casing having a bottom; a cylindrical guide member engaging at one end of the casing; a wax filled in the casing, said wax expanding and contracting due to a temperature change; an elastic sealing member which seals the wax in the casing, said elastic sealing member having a piston insertion bore at the center thereof; and a piston which moves in the axial direction by expanding and contracting of the wax, wherein:
said elastic sealing member has longitudinal grooves on the inner surface of the piston insertion bore in the longitudinal direction of the piston insertion bore, and when the wax expands and the piston is moved upward, the elastic sealing member is bent at the grooves and the piston insertion bore is pushed and deformed.

2. A thermo-element according to claim 1, wherein the piston insertion bore has an inner diameter which is equal to or larger than the outer diameter of the piston when not deformed.

3. A thermo-element according to claim 1, wherein the piston insertion bore has an inner diameter which is smaller than the outer diameter of the piston when not deformed.

4. A thermo-element according to claim 1, wherein the piston insertion bore has an inner diameter which is smaller than the outer diameter of the piston near the entrance of the piston insertion bore, and has an inner diameter which is equal to or larger than the outer diameter of the piston at the lower portion of the piston insertion bore, and the longitudinal grooves are provided on the lower portion which has an inner diameter equal to or larger than the outer diameter of the piston.

5. A thermo-element according to claim 1, wherein the piston insertion bore has a roughened surface, and the elastic sealing member is not adhered to the piston.

6. A thermo-element comprising a cylindrical casing having a bottom; a cylindrical guide member engaging at one end of the casing; a wax filled in the casing, said wax expanding and contracting due to a temperature change; an elastic sealing member which seals the wax in the casing, said elastic sealing member having a piston insertion bore at the center thereof; and a piston which moves in the axial direction by expanding and contracting of the wax, wherein:
said elastic sealing member has longitudinal ribs on the outer surface of the elastic sealing member in the longitudinal direction of the piston insertion bore, and when the wax expands and the piston is moved upward, the elastic sealing member is bent at the ribs and the piston insertion bore is pushed and deformed.

7. A thermo-element according to claim 1, wherein the thermo-element is a sleeve type thermo-element, and wherein the elastic sealing member is a sleeve which seals the wax in the casing and has the piston insertion bore at the center thereof for inserting one end of the piston.

8. A thermo-element according to claim 1, wherein the thermo-element is a thick sealing member made of non-compressive gummy elastic body, arranged between the guide member and the wax for sealing the wax, and having the piston insertion bore at the center thereof.

9. A thermo-element including a wax which expands and contradicts due to a temperature change, and pushes up and down the piston, comprising:
a cylindrical casing having a opening at one end for filling the wax;
a cylindrical guide member engaging at one end of the casing;
a piston slidably positioned in the bore of the guide member; and
a thick sealing member arranged between the guide member and the wax for sealing the wax in the casing, the thick sealing member having a piston insertion bore for inserting one end of the piston, an annular rib at an outer peripheral region thereof, and a thick portion between the rib and the piston insertion bore, the thickness of the thick portion increasing from the rib to the piston insertion bore; wherein
said thick sealing member has longitudinal grooves on the inner surface of the piston insertion bore in the longitudinal direction of the piston insertion bore, and when the wax expands and the piston is moved upward, the thick sealing member is bent at the grooves and the piston insertion bore is pushed and deformed.

10. An elastic sealing member used in a thermo-element in which a piston is moved by expanding and contracting of a wax, wherein
the elastic sealing member has a piston insertion bore at the center thereof; said elastic sealing member has longitudinal grooves on the inner surface of the piston insertion bore in the longitudinal direction of the piston insertion bore, and when the wax expands and the piston is moved upward, the elastic sealing member is bent at the grooves and the piston insertion bore is pushed and deformed.

11. An elastic sealing member used in a thermo-element in which a piston is moved by expanding and contracting of a wax, wherein
the elastic sealing member has a piston insertion bore at the center thereof; said elastic sealing member has longitudinal ribs on the outer surface of the elastic sealing member in the longitudinal direction of the piston insertion bore, and when the wax expands and the piston is moved upward, the elastic sealing member is bent at the ribs and the piston insertion bore is pushed and deformed.
